(19) United States
(12) Patent Application Publication
(10) Pub. No.: US 2026/0192324 A1
(43) Pub. Date: Jul. 9, 2026

(54) Improved Feeding Device for a Coating Apparatus

(71) Applicant: GEA FOOD SOLUTIONS BAKEL B.V., Bakel (NL)

(72) Inventors: Ben Kop, Esch (NL); Stef Verbaarschot, Deurne (NL); Jacobus Johannes Maria Van Der Laak, Milheeze (NL)

(21) Appl. No.: 19/129,321

(22) PCT Filed: Nov. 6, 2023
(86) PCT No.: PCT/EP2023/080831

§ 371 Date: May 13, 2025

(30) Foreign Application Priority Data
Nov. 15, 2022 (EP) 22207488.2

(51) Int. Cl. B05C 11/10

(52) U.S. Cl. CPC B05C 11/1039

(57) ABSTRACT

A feeding device and method for a coating apparatus that includes a hopper to supply fresh granular/powdery material and a funnel with a slide to supply recycled granular/powdery material in a sliding direction, the fresh granular/powdery material and the recycled granular/powdery material being mixed and supplied to the coating apparatus to coat a food product, the hopper includes an outlet, the hopper includes means to guide an outflow of the fresh granular/powdery material from the outlet of the hopper in a, at least partial, counterflow-direction to the sliding direction of the recycled granular/powdery material, the hopper comprises another outlet with a constant outflow area.

### CROSS REFERENCE TO RELATED APPLICATIONS

This application is a U.S. National Stage Entry of PCT/EP2023/080831 filed on Nov. 6, 2023, which claims priority to EP 22207488.2 filed on Nov. 15, 2022, the entireties of which are all incorporated by reference herein for all purposes.

### BACKGROUND

The present invention relates to a feeding device for a coating apparatus comprising a hopper to supply fresh granular/powdery material and a means to supply recycled granular/powdery material, the fresh-and recycled granular/powdery material being mixed and supplied to the coating apparatus to coat a food product. The present invention further relates to a method to supply a granular/powdery material to a coating machine.

Coating apparatus with feeding devices, which are used in the food industry, are well known from the state in the art, for example EP 1 312 269 B1, EP 1 106 085 A1, EP 0 904 704 A1, EP 1226 763 and EP 1 591 023 A1. In the food industry, there is a constant need to improve the quality of the resulting product and/or to optimized the production process.

### SUMMARY

It was therefore the problem of the present invention to provide a feeding device and a method which meet the above mentioned need.

The problem is solved with a feeding device for a coating apparatus comprising a hopper to supply fresh granular/powdery material and a funnel with a slide to supply recycled granular/powdery material in a sliding direction, the fresh-and recycled granular/powdery material being mixed and supplied to the coating apparatus to coat a food product, wherein the hopper comprises an outlet and wherein the hopper comprises means to guide the outflow of fresh granular/powdery material from the outlet in a, at least partial, counterflow-direction to the sliding direction of the recycled granular/powdery material.

The disclosure made regarding this subject matter of the invention also applies to the other subject matters and vice versa. Disclosure made regarding this subject matter can be combined with the disclosure of other subject matters and vice versa.

The present invention relates to a feeding device for a coating apparatus, which coats products such as meat or vegetables or processed food products or vegetarian products such as meat substitute. These products are often coated with a granular/powdery material, such as bread crumbs, but also with nuts, pieces, sweets, chocolate, vegetables, particularly frozen vegetables, coloring material, puffed food products, like puffed rice, or the like. The granular/powdery material is provided to the coating apparatus, which provides a preferably constant layer of granular/powdery material onto the food product to be coated. Preferably, the layer is constant in thickness, in particle-size-distribution and/or color. Preferably, a plurality of products are provided side by side in the coating apparatus and hence coated simultaneously. Since there is in most cases a surplus supply of granular/powdery material to the coating apparatus, this material is collected and at least partially recycled to the feeding apparatus, in the following, the “recycled granular/powdery material”. The amount of recycled granular/powdery material may vary with time. The fresh granular/powdery material is provided in a hopper, which is part of the feeding device. The fresh granular/powdery material preferably exits the hopper by gravity. The fresh-and the recycled granular/powdery material are mixed and then used to coat the food products. Inventively, the recycled granular/powdery material not recycled into the hopper, but to a funnel with a slide, wherein the recycled granular/powdery material slides down the slide by gravity.

According to the present invention, the hopper comprises means to guide the outflow of fresh granular/powdery material from the outlet into the funnel such, that the flow of fresh granular/powdery material from the hopper is in counterflow to the recycled granular/powdery material which slides down the funnel. The skilled person understands, that there need not be a complete counterflow, but that a counterflow-component of the fresh granular/powdery material may be sufficient. The counterflow of fresh granular/powdery material may reduce the sliding velocity of the recycled granular/powdery material. The counterflow of fresh granular/powdery results in a more equalized recycled granular/powdery material in the funnel over the width of the funnel. The counterflow of fresh granular/powdery avoids an uncontrolled drainage of fresh granular/powdery from the hopper.

The means to guide the outflow of fresh granular/powdery material may be inside and/or outside the hopper. The means is for example a sidewall of the hopper in the vicinity of an outlet, which guides the fresh granular/powdery material towards the outlet, so that the fresh granular/powdery material leaves the outlet as a counterflow to the recycled granular/powdery material. Alternatively or additionally, the means can be provided outside from hopper, for example as a plate. Preferably, this plate is adjustable in its angel of inclination, so that the direction of the outflow of the fresh granular/powdery material from the hopper can be altered. Preferably, the means is a pivotable plate. Preferably, this plate is provided in the vicinity of an outlet of the hopper and more preferably works as a valve, which can at least be pivoted from an open-to a closed position and even more preferably also to intermediate positions.

According a preferred embodiment, the hopper comprises a first outlet and a second outlet, wherein the outflow area of the first outlet is fixed, and the outflow area of the second outlet is adjustable. Preferably, the first and second outlets are adjacent to each other, preferably directly adjacent.

The funnel has an axial direction, the sliding direction of the granular/powdery material and preferably a U-shaped cross-section. The “U” has a base, a slide, and two sidewalls representing the flanks of the “U”. The funnel is preferably closed, preferably with a removable lid, which rests or is connected to the flanks of the “U”. The granular/powdery material preferably slides down the axial direction of the funnel. The funnel has a width, which its extension perpendicular to the flow direction of the granular/powdery material. The width of the funnel may vary, for example depending on the width of the coating apparatus and may be for example 400, 600 or 1000 mm.

Another preferred or inventive embodiment of the present invention is a feeding device, which comprises a funnel with a slide and guiding-and/or mixing means in the funnel, which channels and/or redirects and/or mixes the recycled granular/powdery material.

The disclosure made regarding this subject matter of the invention also applies to the other subject matters and vice versa. Disclosure made regarding this subject matter can be combined with the disclosure of other subject matters and vice versa.

According to this aspect of the present invention, the funnel comprises a slide, which is tilted relative to a horizontal plane. The granular/powdery material moves down this slide by gravitational force. In the funnel guiding-and/or mixing means are provided, which channels and/or redirects and/or mixes the recycled granular/powdery material in a channeling-and/or redirecting-and/or mixing region. The mixing results in a more even particle size distribution of the recycled granular/powdery material over the entire width of the funnel. The channeling of the recycled granular/powdery material preferably improves the mixing of the recycled granular/powdery material. The means preferably function as an inline mixer. The guiding-and/or mixing means preferably avoid that, relative to the width of the funnel larger and/or heavier particles such as coarse crumbs accumulate on one side of the funnel, while finer and/or lighter particles accumulate on the opposite side. The guiding-and/or mixing means preferably avoid that the extension of a layer of granular/powdery material, which builds up upstream form the outlet of the hopper differs in length and or in height over the width of the funnel.

Downstream from the guiding-and/or mixing means, the recycled granular/powdery material preferably spreads of the entire width of the funnel and more preferably leads to a layer of recycled granular/powdery material, preferably upstream from outlet of the hopper that discharges the fresh granular/powdery material, whose particle size distribution is at least essentially constant and/or whose extension in axial direction of the funnel is essentially constant and/or whose thickness is essentially constant.

According to a preferred embodiment of the present invention, the guiding-and/or mixing means comprises at least a first- and a second guiding- and/or mixing means, each being preferably spaced apart from each other and/or each being provided in the funnel at different locations. Preferably, the guiding- and/or mixing means are pivotable relative to the funnel, more preferably around an axis that is perpendicular to the sliding plane. According to a preferred embodiment, three or more guiding- and/or mixing means are provided. For example, depending on the width of the funnel more than three more guiding-and/or mixing means can be provided. Preferably, the larger the width, the more guiding- and/or mixing means will be installed.

Preferably, the first- and the second and, preferably a third, guiding- and/or mixing means are each a plate, preferably a pivotable plate. Preferably, each plate has its own pivot axis, each axis being spaced apart from the others. The pivot axis of the two or more guiding- and/or mixing means are preferably located in different axial directions of the funnel.

Preferably, the first- and a second guiding- and/or mixing means differ in shape and/or size and/or the location at which they are provided in the funnel is different, particularly the location in the axial direction of the funnel.

According to a preferred embodiment of the present invention, the first- and a second guiding- and/or mixing means are adjustable in their position relative to each other and/or to the funnel. This adjustment, for example, changes the size, preferably the width of channeling- and/or mixing region. A reduced size of the channeling and/or mixing region may result in an improved mixing and hence preferably in an improved particle size distribution.

Preferably, at least one of the guiding- and/or mixing means comprises an overflow section, preferably provided in the channeling and/or mixing region. The overflow section is overflown by the recycled granular/powdery material and improves its mixing. The overflow preferably works as an inline mixer.

Another inventive or preferred embodiment of the present invention is a feeding device with a chute which discharges recycled granular/powdery material into the funnel, wherein the chute is adjustable in its angle of inclination.

The disclosure made regarding this subject matter of the invention also applies to the other subject matters and vice versa. Disclosure made regarding this subject matter can be combined with the disclosure of other subject matters and vice versa.

According to this embodiment of the present invention, the feeding device comprises a chute which discharges the recycled granular/powdery material into the funnel. Preferably, the cute can be provided with different length, more preferably depending the width of the chute. This chute is now adjustable in its angle of inclination, preferably relative to the plane of the slide of the funnel.

Another inventive or preferred embodiment of the present invention is a feeding device comprises means to distribute the fresh granular/powdery material evenly in the hopper.

The disclosure made regarding this subject matter of the invention also applies to the other subject matters and vice versa. Disclosure made regarding this subject matter can be combined with the disclosure of other subject matters and vice versa.

According to this preferred embodiment of the present invention, the fresh granular/powdery material is evenly distributed in the hopper, so that the fresh granular/powdery material in the hopper has at least essentially a flat and/or horizontal surface. The fresh material is preferably constantly and more preferably not batch-wise supplied to the hopper. Upstream from the hopper and/or in the hopper, the incoming flow of fresh granular/powdery material is distributed over the entire surface area of the hopper. The fresh granular/powdery material preferably exits the hopper by gravity.

Preferably, the fresh- and the recycled granular/powdery material are combined, more preferably in the funnel. The fresh granular/powdery material may be provided by at least two streams, wherein one stream is adjustable. More preferably, both streams exit a hopper and even more preferably are then combined with the recycled granular/powdery material. Preferably, the adjustable stream of fresh granular/powdery material is provided upstream from the other stream of fresh granular/powdery material relative to the flow of recycled granular/powdery material.

Preferably, the combined flow of fresh- and recycled granular/powdery material is controlled, preferably with a valve, more preferably with a linear valve. The valve is preferably provided downstream from the hopper and/or in the funnel, more preferably at the discharge end of the funnel, before the granular/powdery material is supplied to the coating apparatus.

Another embodiment of the present invention is a method to supply a granular/powdery material to a coating machine, preferably by a device according to one of the preceding claims, the granular/powdery material comprising fresh and recycled granular/powdery material, wherein the recycled granular/powdery material slides down a slide in a funnel in a sliding direction, and wherein the recycled granular/powdery material is channeled and/or redirected and/or mixed in the funnel prior to its combination with the fresh granular/powdery material.

The disclosure made regarding this subject matter of the invention also applies to the other subject matters and vice versa. Disclosure made regarding this subject matter can be combined with the disclosure of other subject matters and vice versa.

According to this aspect of the present invention, the recycled granular/powdery material is channeled, redirected and/or mixed prior to its combination with fresh granular/powdery material. This channeling, redirecting and/or mixing preferably takes place in the funnel, more preferably after it has been discharged from the chute and more preferably upstream from the hopper, particularly its outlet of fresh granular/powdery material.

Another preferred or inventive embodiment of the present invention is a method, wherein the recycled granular/powdery material forms a layer on the slide prior to its combination with the fresh granular/powdery material, the layer having an essentially constant extension in the axial direction of the funnel and/or a constant height over the entire width of the funnel.

The disclosure made regarding this subject matter of the invention also applies to the other subject matters and vice versa. Disclosure made regarding this subject matter can be combined with the disclosure of other subject matters and vice versa.

This embodiment of the present invention has the advantage that the outflow of fresh granular/powdery material is constant over the entire width of the hopper and/or that the coating of each products is at least essentially the same.

Preferably, the particle size distribution is at least essentially constant in the layer, more preferably over its entire extension.

Another preferred or inventive embodiment of the present invention is a method wherein the fresh granular/powdery material is fed to the funnel in an at least partial counterflow-direction to the sliding-direction of the recycled granular/powdery material.

The disclosure made regarding this subject matter of the invention also applies to the other subject matters and vice versa. Disclosure made regarding this subject matter can be combined with the disclosure of other subject matters and vice versa.

The counterflow of fresh granular/powdery material preferably reduces the speed of the landslide of the recycled granular/powdery material. The counterflow of fresh granular/powdery material preferably improves the axial extension of the layer of recycled granular/powdery material upstream from the outlet of the hopper. The counterflow of fresh granular/powdery material preferably equalizes the height of the layer of recycled granular/powdery material.

The fresh granular/powdery material may be provided by at least two streams, wherein one stream is adjustable.

The inventions are now explained according to the Figures. These explanations apply to all inventions likewise. The embodiments in the Figures are only examples and do not limit the scope of the general concept of the present invention.

### BRIEF DESCRIPTION OF THE DRAWINGS

FIGS. 1-5 illustrate details of the inventive feeding device and the inventive method.

FIG. 1 shows an overview of the inventive feeding device for granular/powdery material.

FIG. 2 shows a detail of the embodiment according to FIG. 1.

FIG. 3 shows a detail of the inlet of the funnel.

FIG. 4 shows an embodiment of the guiding-and mixing means provided in the funnel.

FIG. 5 shows an embodiment of the guiding-and mixing means provided in the funnel.

### DETAILED DESCRIPTION

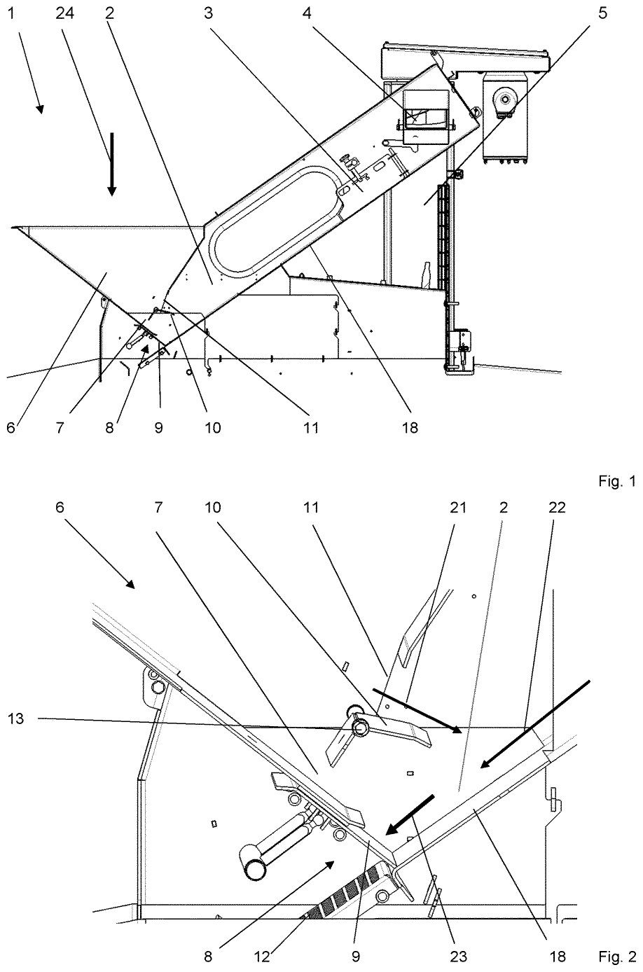

FIG. 1 shows an overview of the inventive feeding device 1 for granular/powdery material, which comprises a hopper 6, which receives a, preferably continuous, inflow 24 of fresh granular/powdery material. The device 1 further comprises a funnel 2 with a, preferably continuous, supply of recycled granular/powdery material via the transportation means 5, for example a feeder-worm, and here a chute 4. The recycled granular/powdery material is granular/powdery material that has already been used during a previous coating process in a coating apparatus connected to the feeding device. After the recycled granular/powdery material has been supplied to the funnel 2, it slides down a slide 18 by gravity towards the hopper 6 and is then combined with the fresh granular/powdery material that exits the hopper via an outlet. In the present example the hopper comprise two outlets 7, 11, but the person skilled in the art understands that one outlet may be sufficient. The combined flow of fresh-and recycled granular/powdery material then slides towards the outlet of the feeding device and towards the coating apparatus. The outlet of the funnel has an opening 8, whose size of the outflow area can preferably be adjusted with means 9, here a linear valve. The means 9, here a linear valve, adjust the flow of the combined fresh-and recycled flow of granular/powdery material towards the coating machine.

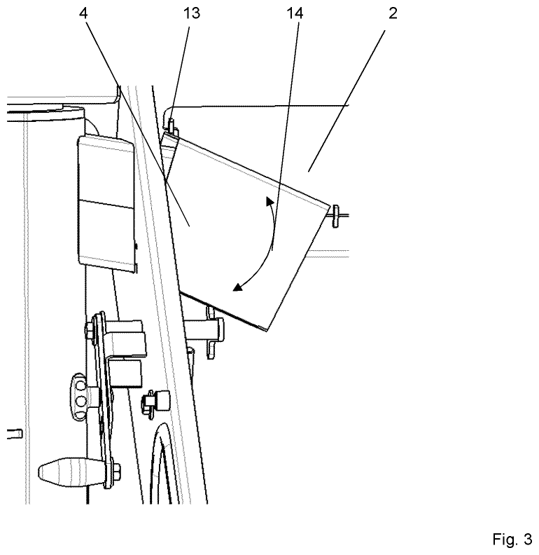

FIG. 2 shows a detail of the embodiment according to FIG. 1. Here, the outlet of the hopper 6 and the outlet of the funnel 2 is depicted. The recycled granular/powdery material slides down the slide 18 in a sliding direction 22. Fresh granular/powdery material exits the hopper 6 in a flow direction 21. The flow of fresh granular/powdery material is guided in the direction 22 by the means 10, here a plate. The direction 21 has a counterflow component towards the sliding direction 22, which may cause a deceleration of the slide of the recycled granular/powdery material. The means 10 is in the present case pivotable around an axis to adjust the direction of the flow 21 and/or the magnitude of the flow itself, preferably to zero. In the present case, the hopper has an optional second outlet 7. The outflow area of this outlet is preferably not adjustable. In the vicinity of the outlet(s) 7, 11, the flow of fresh-and recycled granular/powdery material 21, 22 is combined and the granular/powdery material slides down the funnel towards its opening 8. The outflow of granular/powdery material can here be controlled by means 9, here a linear valve. After the granular/powdery material has exited the funnel, it is supplied to the coating apparatus 12.

FIG. 3 shows a detail of the inlet of the funnel 2. The recycled granular/powdery material is preferably discharged into the funnel 2 by a chute 4. In the present case and according to a preferred embodiment, this chute is pivotable around a pivot 13 as depicted by double arrow 14.

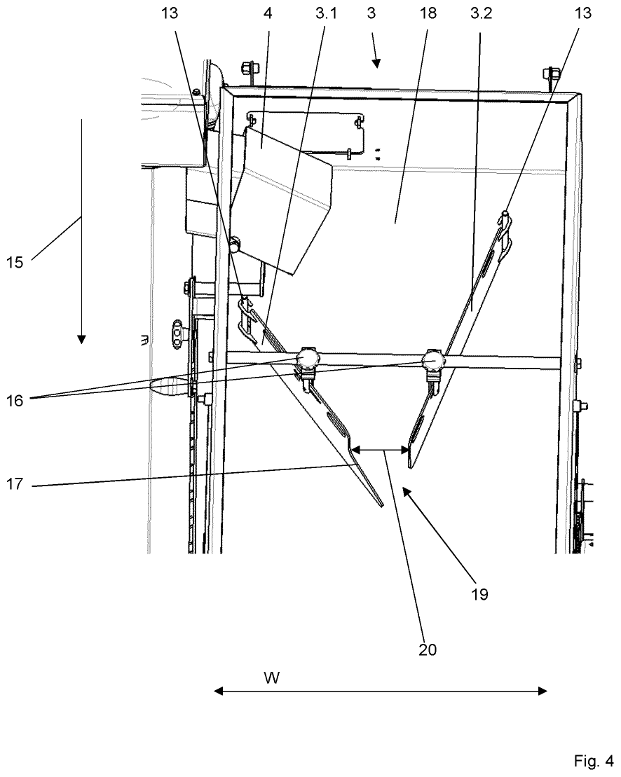

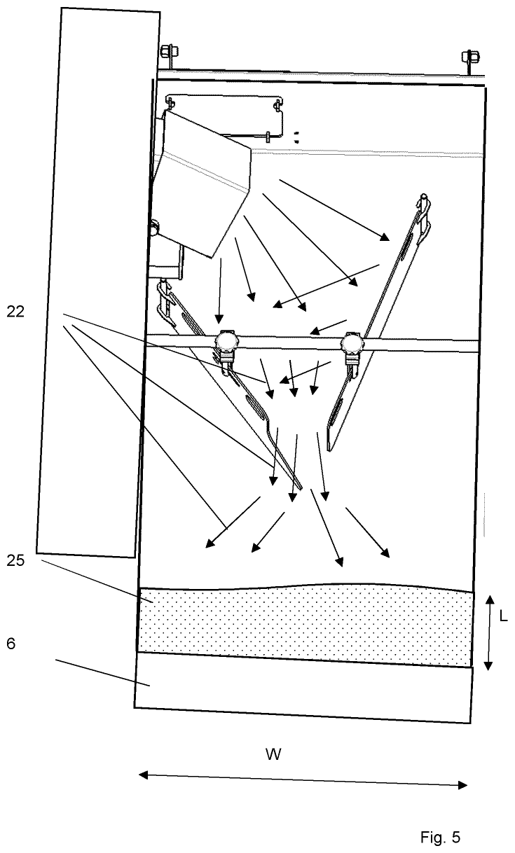

FIGS. 4 and 5 show an embodiment of the guiding-and mixing means 3 provided in the funnel 2. The funnel 2 has in the present case a U-shaped cross section. The cross section of the funnel is perpendicular to the axial direction of the funnel. The funnel has a width W. Along the axial direction 15, the recycled granular/powdery material slides downwards by gravity, after it has been supplied to the funnel by means 4, 5. The guiding-and mixing means 3 comprises in the present case a first guiding-and mixing means 3.1 and a second guiding-and mixing means 3.2. The person skilled in the art understands that there can be additional guiding-and mixing means, which are not depicted. The following explanations apply to the additional guiding-and mixing means likewise. The first-and the second guiding-and mixing means 3.1. 3.2 are provided in the funnel 2, downstream from the inlet 4 of the recycled granular/powdery material into the funnel. The means are provided adjustable in the funnel. In the present case, the means 3.1, 3.2 are each pivotable around a pivot 13, so that their pivot-angle can be adjusted and fixed by fixation means 16. The pivots 13 of the guiding-and mixing means 3.1, 3.2 are located apart and/or at different axial locations in the funnel. The guiding-and mixing means 3.1, 3.2 are in the present case each provided as a plate, wherein the guiding-and mixing means 3.1 has here an overflow region 17 here at its end. The overflow region 17 is here a region with a reduced height of the plate. Preferably, in the overflow region 17, the height of the plate decreases towards the end of plate 3.1. The overflow region 17 is optional. In the present case, the first and the second guiding-and mixing means 3,1, 3.2 are in a V-shaped configuration, with a channeling and/or mixing region 19, here at the bottom of the “V”. The width 20 of the region 19 and/or its location in the funnel is adjustable, by adjusting the angel of inclination of the first-and/or second guiding-and mixing means 3.1, 3.2. In the region 19, the recycled granular/powdery material is channeled and mixed, The mixing is improved by the overflow section 17, which works like a static mixer. The person skilled in the art understand, that the first and the second guiding-and mixing means 3,1, 3.2 need not be V-shaped, but can be configured differently, for example in parallel.

The flow of the particles along the funnel 2 is schematically depicted in FIG. 5. Normally, the recycled granular/powdery material is ejected by the inlet 4, here a chute, so that larger and/or heavier particles ted to slide towards the guiding-and mixing means 3.2, while smaller and/or lighter particles tend to slide in the direction of the guiding-and mixing means 3.1. Due to the guiding-and mixing means 3.1, 3.2, the flow 22 of the particles of the recycled granular/powdery material is redirected and channeled towards the channeling and/or mixing region 19, where the smaller/lighter and larger/heavier particles of the recycled granular/powdery material are mixed, preferably to a homogeneous mixture. Downstream from the channeling and/or mixing region 19, the mixture spreads again, preferably over the entire width W of the funnel and preferably forms a layer 25 upstream from the outlet of the hopper. Due to the guiding and/or mixing means 3, this layer has preferably an essential length L in the axial direction of funnel over the width W as depicted and/or the layer 25 has a constant height and/or an essentially homogeneous particle size distribution.

### LIST OF REFERENCE SIGNS

1 Feeding device for granular/powdery material
2 Funnel
3 Guiding-and/or mixing means
3.1 first guiding and/or mixing means
3.2 second guiding and/or mixing means
4 Inlet, chute
5 Transportation means
6 Hopper
7 First outlet of the hopper 6
8 Opening for combined outflow
9 Adjustment means for the opening 8
10 means to guide the outflow from the hopper and/or adjustment means for the opening 11
11 Second outlet of the hopper
12 Coating apparatus
13 Pivot
14 Angle of inclination of the chute 4
15 Axial direction of the funnel
16 Fixation means
17 Overflow section at one guiding and/or mixing means
18 Slide
19 Channeling-and/or redirecting-and/or mixing region
20 Width of the channeling-and/or mixing region
21 Flow of fresh granular/powdery material
22 Sliding direction of recycled granular/powdery material
23 Combined flow of fresh-and recycled granular/powdery material
24 Inflow of fresh granular/powdery material to the hopper
25 Layer of recycled granular/powdery material
W width of the funnel
L length of the layer of recycled granular/powdery material

1. Feeding device for a coating apparatus comprising a hopper to supply fresh granular/powdery material and a funnel with a slide to supply recycled granular/powdery material in a sliding direction, the fresh granular/powdery material and the recycled granular/powdery material being mixed and supplied to the coating apparatus to coat a food product, wherein the hopper comprises an outlet, the hopper comprises means to guide an outflow of the fresh granular/powdery material from the outlet of the hopper in a, at least partial, counterflow-direction to the sliding direction of the recycled granular/powdery material, wherein the hopper comprises another outlet with a constant outflow area.

2. Feeding device according to claim 1, wherein the means to guide the outflow of the fresh granular/powder material is a plate or a pivotable plate, which alters a size outflow area of the outlet and/or a direction of the outflow of the fresh granular/powdery material.

3. (canceled)

4. Feeding device according to claim 1, wherein the feeding device comprises guiding- and/or mixing means in the funnel, which channels and/or redirects and/or mixes the recycled granular/powdery material.

5. Feeding device according to claim 4, wherein the guiding- and/or mixing means comprises at least a first guiding- and/or mixing and a second guiding- and/or mixing means.

6. Feeding device according to claim 5, wherein the fust guiding- and/or mixing means and second guiding- and/or mixing means are each a plate or a pivotable plate.

7. Feeding device according to claim 5, wherein the first guiding- and/or mixing means and the second guiding- and/or mixing means differ in shape, size and/or the location at which they are provided in the funnel.

8. Feeding device according to claim 5, wherein the first guiding- and/or mixing means and the second guiding- and/or mixing means are each adjustable in a position relative to each other and/or to the funnel.

9. Feeding device according to claim 1, comprising a chute which discharges the recycled granular/powdery material into the funnel wherein the chute is adjustable in its angle of inclination.

10. (canceled)

11. Feeding device according to claim 1, comprising means to distribute the fresh granular/powdery material evenly in the hopper.

12. Method to supply the granular/powdery material to the coating machine, by the feeding device according to claim 1, the granular/powdery material comprising the fresh granular/powdery material and the recycled granular/powdery material, wherein the recycled granular/powdery material slides down the slide in the funnel in the sliding direction, the recycled granular/powdery material is channeled and/or redirected and/or mixed in the funnel prior to its combination with the fresh granular/powdery material.

13. Method according to claim 12, wherein the recycled granular/powdery material forms a layer on the slide prior to its combination with the fresh granular/powdery material, the layer having an essentially constant length and/or height over an entire width of the funnel.

14. Method according to claim 12, wherein the fresh granular/powdery material is fed to the funnel in an at least partial counterflow-direction to the sliding-direction of the recycled granular/powdery material.

15. Method according to claim 12, wherein the fresh granular/powdery material is provided by at least two streams, wherein one stream is adjustable.
